(19) United States
(12) Patent Application Publication
(10) Pub. No.: US 2010/0093386 A1
(43) Pub. Date: Apr. 15, 2010

(54) Random access for wireless communication

(75) Inventors: Aleksandar Damnjanovic, Del Mar, CA (US); Durga Prasad Malladi, San Diego, CA (US); Juan Montojo, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/443,783

(22) PCT Filed: Oct. 31, 2007
(86) PCT No.: PCT/US07/83239

§ 371 Date: Jul. 2, 2009

Related U.S. Application Data
(60) Provisional application No. 60/855,903, filed on Oct. 31, 2006.

(51) Int. Cl. H04B 7/005

(52) U.S. Cl. 455/522

(57) ABSTRACT

Techniques for sending messages for system access are described. In one aspect, a user equipment (UE) sends a first message with power headroom and/or buffer size information for system access. A Node B determines at least one parameter (e.g., a resource grant, power control information, etc.) based on the power headroom and/or buffer size information. The Node B sends a second message with the parameter(s). The UE sends a third message based on the parameter(s), e.g., with uplink resources indicated by the resource grant, with transmit power determined based on the power control information, etc. In another aspect, the UE sends a radio environment report in the third message. The report may be used to select a cell and/or a frequency for the UE. In yet another aspect, the second message includes power control information, and the UE sends the third message based on the power control information.

The present application claims priority to provisional U.S. application Ser. No. 60/855,903, entitled “RANDOM ACCESS FOR WIRELESS COMMUNICATION,” filed Oct. 31, 2006, assigned to the assignee hereof and incorporated herein by reference.

### BACKGROUND

I. Field

The present disclosure relates generally to communication, and more specifically to techniques for accessing a wireless communication system.

II. Background

Wireless communication systems are widely deployed to provide various communication content such as voice, video, packet data, messaging, broadcast, etc. These wireless systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

A wireless communication system may include any number of Node Bs that can support communication for any number of user equipments (UEs). A UE may communicate with a Node B via transmissions on the downlink and uplink. The downlink (or forward link) refers to the communication link from the Node B to the UE, and the uplink (or reverse link) refers to the communication link from the UE to the Node B.

A UE may transmit a random access preamble (or an access probe) on the uplink when the UE desires to gain access to the system. A Node B may receive the random access preamble and respond with a random access response (or an access grant) that may contain pertinent information for the UE. The UE and Node B may exchange additional messages to complete the system access for the UE. Uplink resources are consumed to transmit messages on the uplink, and downlink resources are consumed to transmit messages on the downlink for the system access. There is therefore a need in the art for techniques to efficiently send messages for system access.

### SUMMARY

Techniques for sending messages for system access are described herein. In one aspect, a UE may send a first message (e.g., a random access preamble) comprising power headroom information and/or buffer size information for system access. A Node B may determine at least one parameter (e.g., a resource grant, power control information, etc.) based on the power headroom and/or buffer size information. The Node B may return a second message (e.g., a random access response) comprising the at least one parameter. The UE may then send a third message based on the at least one parameter. For example, the UE may send the third message with uplink resources indicated by the resource grant, with transmit power determined based on the power control information, etc.

In another aspect, the UE may send a radio environment report in the third message. This report may include pilot measurements for multiple cells, multiple frequencies, and/or multiple systems. The report may be used to select a frequency and/or a cell for the UE.

In yet another aspect, the UE may receive power control information in the second message and may send the third message with transmit power determined based on the power control information. The Node B may determine the power control information based on received signal quality of the first message, power headroom information sent in the first message, etc. The UE may determine the transmit power for the third message based on the power control information received in the second message and the transmit power used for the first message.

Various aspects and features of the disclosure are described in further detail below.

### BRIEF DESCRIPTION OF THE DRAWINGS

FIG. 1 shows a wireless multiple-access communication system.

FIG. 2 shows a block diagram of a Node B and a UE.

FIG. 3 shows an initial access procedure.

FIG. 4 shows an access procedure for forward handover.

FIG. 5 shows an access procedure for basic handover.

FIGS. 6 and 7 show a process and an apparatus, respectively, for performing system access by the UE.

FIGS. 8 and 9 show a process and an apparatus, respectively, for supporting system access by the Node B.

FIGS. 10 and 11 show another process and apparatus, respectively, for performing system access by the UE.

FIGS. 12 and 13 show another process and apparatus, respectively, for supporting system access by the Node B.

FIGS. 14 and 15 show yet another process and apparatus, respectively, for performing system access by the UE.

FIGS. 16 and 17 show yet another process and apparatus, respectively, for supporting system access by the Node B.

### DETAILED DESCRIPTION

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other CDMA variants. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA, E-UTRA and GSM are part of Universal Mobile Telecommunication System (UMTS). 3GPP Long Term Evolution (LTE) is an upcoming release of UMTS that uses E-UTRA, which employs OFDMA on the downlink and SC-FDMA on the uplink. UTRA, E-UTRA, GSM, UMTS and LTE are described in documents from an organization named “3rd Generation Partnership Project” (3GPP). cdma2000 and UMB are described in documents from an organization named “3rd Generation Partnership Project 2” (3GPP2). These various radio technologies and standards are known in the art. For clarity, certain aspects of the techniques are described below for system access in LTE, and 3GPP terminology is used in much of the description below.

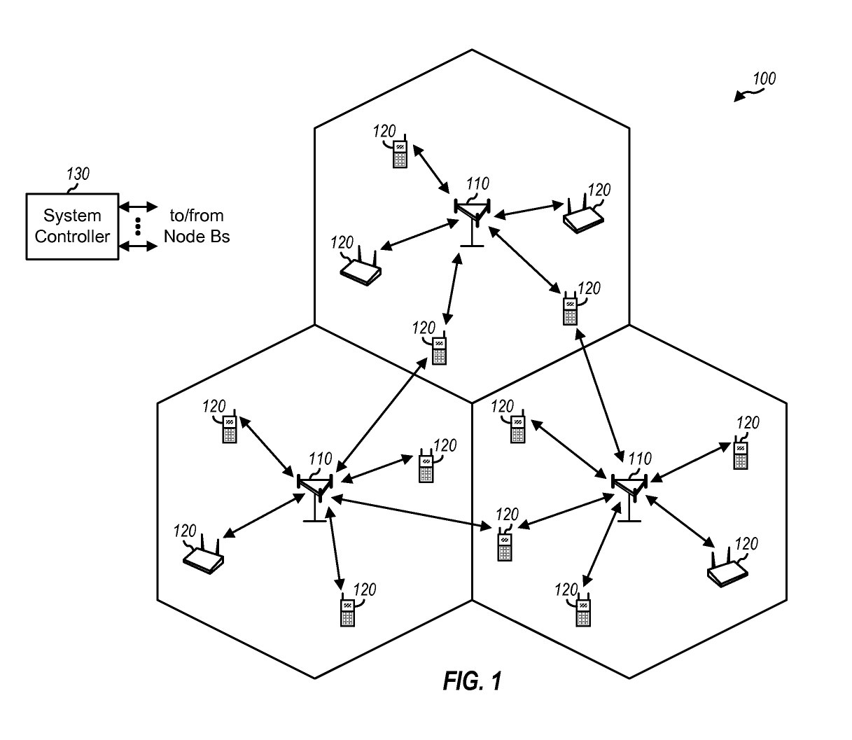

FIG. 1 shows a wireless multiple-access communication system 100 with multiple Node Bs 110. A Node B may be a fixed station used for communicating with the UEs and may also be referred to as an evolved Node B (eNB), a base station, an access point, etc. Each Node B 110 provides communication coverage for a particular geographic area. The overall coverage area of each Node B 110 may be partitioned into multiple (e.g., three) smaller areas. In 3GPP, the term “cell” can refer to the smallest coverage area of a Node B and/or a Node B subsystem serving this coverage area. In other systems, the term “sector” can refer to the smallest coverage area and/or the subsystem serving this coverage area. For clarity, 3GPP concept of cell is used in the description below.

UEs 120 may be dispersed throughout the system. A UE may be stationary or mobile and may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, etc. A UE may communicate with one or multiple Node Bs via transmissions on the downlink and uplink.

A system controller 130 may couple to Node Bs 110 and provide coordination and control for the Node Bs. System controller 130 may be a single network entity or a collection of network entities.

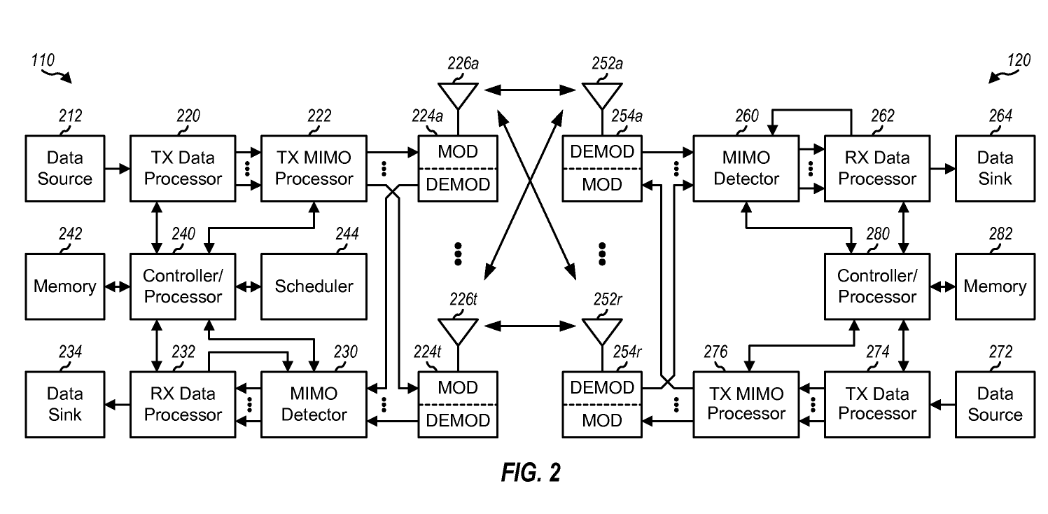

FIG. 2 shows a block diagram of a design of Node B 110 and UE 120, which are one of the Node Bs and one of the UEs in FIG. 1. In this design, Node B 110 is equipped with T antennas 226a through 226t, and UE 120 is equipped with R antennas 252a through 252r, where in general T≧1 and R≧1. Each antenna may be a physical antenna or an antenna array.

At Node B 110, a transmit (TX) data processor 220 may receive traffic data for one or more UEs from a data source 212. TX data processor 220 may process (e.g., format, encode, interleave, and symbol map) the traffic data for each UE based on one or more modulation and coding schemes selected for that UE to obtain data symbols. TX data processor 220 may also receive and process signaling messages from a controller/processor 240 and provide signaling symbols. TX data processor 220 may also generate and multiplex pilot symbols with the data and signaling symbols. A TX MIMO processor 222 may perform spatial processing on the data, signaling and/or pilot symbols based on direct MIMO mapping, precoding/beamforming, etc. A symbol may be sent from one antenna for direct MIMO mapping or from multiple antennas for precoding/beamforming. TX MIMO processor 222 may provide T output symbol streams to T modulators (MODs) 224a through 224t. Each modulator 224 may process its output symbol stream (e.g., for OFDM) to obtain an output chip stream. Each modulator 224 may further condition (e.g., convert to analog, filter, amplify, and upconvert) its output chip stream to obtain a downlink signal. T downlink signals from modulators 224a through 224t may be transmitted via T antennas 226a through 226t, respectively.

At UE 120, antennas 252a through 252r may receive the downlink signals from Node B 110 and provide received signals to demodulators (DEMODs) 254a through 254r, respectively. Each demodulator 254 may condition (e.g., filter, amplify, downconvert, and digitize) its received signal to obtain samples and may further process the samples (e.g., for OFDM) to obtain received symbols. A MIMO detector 260 may perform MIMO detection on the received symbols from all R demodulators 254a through 254r and provide detected symbols. A receive (RX) data processor 262 may process (e.g., symbol demap, deinterleave, and decode) the detected symbols and provide decoded data to a data sink 264 and decoded signaling messages to a controller/processor 280.

On the uplink, at UE 120, traffic data from a data source 272 and signaling messages from controller/processor 280 may be processed by a TX data processor 274, further processed by a TX MIMO processor 276, conditioned by modulators 254a through 254r, and transmitted to Node B 110. At Node B 110, the uplink signals from UE 120 may be received by antennas 226, conditioned by demodulators 224, detected by a MIMO detector 230, and processed by an RX data processor 232 to obtain the traffic data and signaling messages transmitted by UE 120.

Controllers/processors 240 and 280 may direct the operation at Node B 110 and UE 120, respectively. Memories 242 and 282 may store data and program codes for Node B 110 and UE 120, respectively. A scheduler 244 may schedule UEs for downlink and/or uplink transmission and may provide assignments of resources for the scheduled UEs.

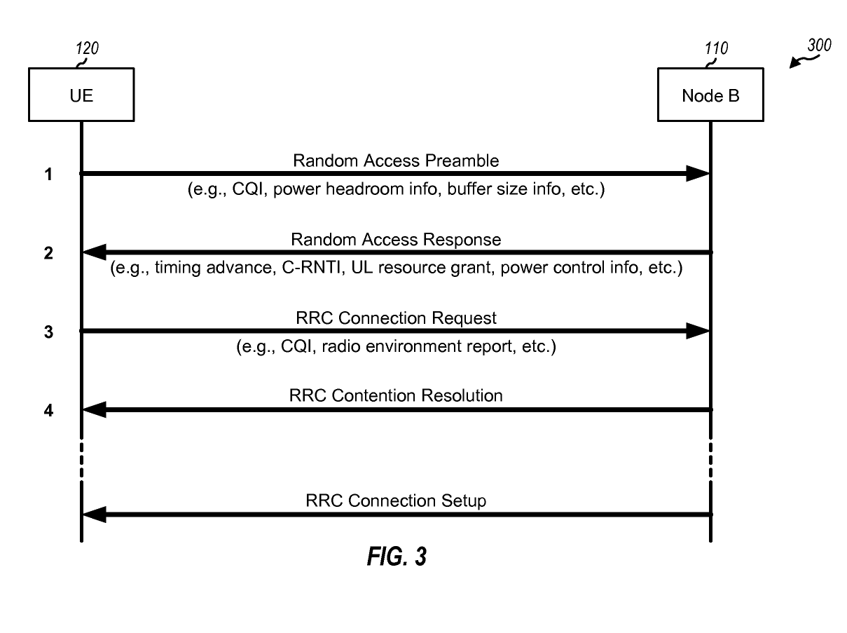

FIG. 3 shows a design of an initial access procedure 300. UE 120 may transmit a random access preamble on a Random Access Channel (RACH) whenever the UE desires to access the system, e.g., at power up, if the UE has data to send, if the UE is paged by the system, etc. A random access preamble is a message that is sent first for system access and may also be referred to as Message 1, an access signature, an access probe, a random access probe, a signature sequence, a RACH signature sequence, etc. The random access preamble may include various types of information and may be sent in various manners, as described below.

Node B 110 may receive the random access preamble from UE 120 and may respond by sending a random access response to UE 120. A random access response may also be referred to as Message 2, an access grant, an access response, etc. The random access response may carry various types of information and may be sent in various manners, as described below. UE 120 may receive the random access response and may send Message 3 for Radio Resource Control (RRC) connection request. Message 3 may contain various types of information as described below. Node B 110 may respond with Message 4 for RRC contention resolution. Node B 110 may also send a message for RRC connection setup, etc. UE 120 and Node B 110 may thereafter exchange data.

FIG. 3 shows a generic message flow for system access. In general, each message may carry various types of information and may be sent in various manners.

The system may support one set of transport channels for the downlink and another set of transport channels for the uplink. These transport channels may be used to provide information transfer services to Medium Access Control (MAC) and higher layers. The transport channels may be described by how and with what characteristics information is sent over a radio link. The transport channels may be mapped to physical channels, which may be defined by various attributes such as modulation and coding, mapping of data to resource blocks, etc. The transport channels may include a Downlink Shared Channel (DL-SCH) used to send data to the UEs, an Uplink Shared Channel (UL-SCH) used to send data by the UEs, one or more RACHs used by the UEs to access the system, etc. The DL-SCH may also be referred to as a Downlink Shared Data Channel (DL-SDCH) and may be mapped to a Physical Downlink Shared Channel (PDSCH). The UL-SCH may also be referred to as an Uplink Shared Data Channel (UL-SDCH) and may be mapped to a Physical Uplink Shared Channel (PUSCH). The RACHs may be mapped to a Physical Random Access Channel (PRACH).

Message 1 in FIG. 3 may carry the random access preamble and may include L bits of information, where L may be any integer value. Message 1 may include any of the following:
Random identifier (ID)—a pseudo-random value selected by UE 120,
Access type—indicate initial system access or handover,
Channel quality indicator (CQI)—used to more efficiently send Message 2,
Power headroom information—used to control transmission of Message 3,
Buffer size information—used to control transmission of Message 3, and
Other information.

The random ID may be used to identify UE 120 during system access but may not be unique since multiple UEs may select the same random ID. In case of collision in the random ID, contention may be resolved using a contention resolution procedure.

The CQI may indicate the downlink channel quality as measured by UE 120 and may be used to send subsequent downlink transmission to the UE and/or to assign uplink resources to the UE. The CQI may be conveyed with 1 bit, 2 bits, or some other number of bits. In general, the advantage of sending the CQI in Message 1 may be greater when Message 2 is larger. The inclusion of the CQI in Message 1 may also enable grouping of random access preambles from different UEs based on their CQIs and hence better power control of Message 2 sent to these UEs. If Message 2 is relatively small and Message 4 is large, then the CQI may be sent in Message 3 instead of Message 1.

Power headroom information may be included in Message 1 and may convey the available transmit power at UE 120. In one design, the power headroom information comprises a single bit that indicates whether the difference between the maximum transmit power at UE 120 and the transmit power used by the UE for Message 1 is above a threshold (e.g., 5 dB or some other value). In another design, the power headroom information comprises multiple bits and indicates the difference between the maximum transmit power at UE 120 and the transmit power used for Message 1.

The power headroom information in addition to the received power of Message 1 may more information than path loss alone. As an example, two UEs may measure the same path loss for a given Node B, and may send their Message 1 with the same transmit power. However, a UE with a maximum transmit power of 24 dBm would have more power headroom than a UE with a maximum transmit power of 21 dBm. Hence, UE 120 may send the power headroom information in Message 1 to Node B 110, and Node B 110 may use this information to control the transmission of Message 3 by UE 120, e.g., to assign uplink resources for Message 3.

Buffer size information may be included in Message 1 and may indicate the amount of data to send in Message 3 by UE 120. Message 3 may carry various types of information such as RRC messages, a radio environment report, etc., and may have a variable size. In one design, the buffer size and power headroom information may be sent separately using a sufficient number of bits for each type of information. In another design, the buffer size and power headroom information may be combined. For example, a larger Message 3 may be selected if UE 120 has sufficient transmit power and sufficient amount of data, and a smaller Message 3 may be selected otherwise. In both designs, log₂(N) bits may be used to support N different sizes for Message 3. In any case, the buffer size and/or power headroom information may allow Node B 110 to assign appropriate uplink resources for Message 3.

An access sequence may be selected from a pool of 2^{L} available access sequences and sent for the random access preamble in Message 1. In one design, L=6, and an access sequence may be selected from a pool of 64 access sequences and sent for a 6-bit random access preamble. An L-bit index of the selected access sequence may be referred to as an RA-preamble identifier.

In one design, which is referred to as access procedure option 1, one or more of the following features may be supported:
Message 2 is sent on both L1/L2 control and the DL-SCH,
A Cell Radio Network Temporary Identifier (C-RNTI) is assigned to UE 120 in Message 2,
UE 120 is identified based on a Random Access RNTI (RA-RNTI) before the C-RNTI is assigned,
Message 3 has a dynamic size, and
Message 4 (contention resolution) and RRC connection setup may be merged.

Option 1 may provide more flexibility since Node B 110 can respond to the random access preamble from UE 120 with a large Message 2, which may be sent on both L1/L2 control and the DL-SCH. L1/L2 control refers to a mechanism used by Layer 1/Layer 2 for sending signaling/control information. L1/L2 control may be implemented with a Physical Downlink Control Channel (PDCCH), a Shared Downlink Control Channel (SDCCH), etc.

The C-RNTI may be used to uniquely identify UE 120 by Node B 110 and may be assigned to the UE during the access procedure (e.g., in Message 2 or 4) or at some other time. The C-RNTI may also be referred to as a MAC ID, etc. UE 120 may be identified by a temporary ID until the C-RNTI is assigned. Multiple RACHs may be available, and UE 120 may randomly select one of the available RACHs. Each RACH may be associated with a different RA-RNTI. During the system access, UE 120 may be identified by a combination of the RA-preamble identifier for the access sequence sent by the UE and the RA-RNTI of the selected RACH.

Node B 110 may respond to Message 1 from UE 120 with Message 2, which may be a large message capable of carrying various types of information. Node B 110 may convey the following information to UE 120 in Message 2:
Timing advance (˜8 bits)—used to adjust the timing of UE 120,
RA-RNTI (˜16 bits)—identify the RACH being responded to by Node B 110,
RA-preamble identifier (6 bits)—identify the random access preamble being responded to by Node B 110, and
Uplink resources (˜24 bits)—identify uplink resources allocated to UE 120.

In addition, Message 2 may also include any of the following:
C-RNTI (16 bits)—the C-RNTI assigned to UE 120,
MAC header (˜8 bits),
Message type (˜8 bits),
Power adjustment/power control information for Message 3 (˜4-6 bits), and
Other information such as CQI resources, etc.

The C-RNTI may be assigned to UE 120 in Message 2. Multiple UEs may send the same random access preamble on the same RACH and may thus collide. In case of collisions, these UEs may be assigned the same C-RNTI. However, only the UE that successfully resolves contention would retain the assigned C-RNTI while other UEs would access the system again and obtain new C-RNTIs when they repeat the access procedure. The C-RNTI may also be assigned to UE 120 in Message 4.

The RA-RNTI may be used as a temporary UE ID before the C-RNTI is assigned to UE 120. The RA-RNTI may identify the RACH and not the random access preamble. Message 2 may be addressed to a particular RA-RNTI and may thus be broadcast in nature. Also, the use of the RA-RNTI may imply that Message 2 is sent on both L1/L2 control and the DL-SCH since the capacity of L1/L2 control alone may be too small. If both L1/L2 control and the DL-SCH are used to send Message 2, then a benefit of using the RA-RNTI is that a single L1/L2 control channel may be used to address multiple UEs whose random access preambles were successfully received on the associated RACH by Node B 110. However, these gains should be evaluated in light of the low likelihood of receiving multiple random access preambles on the same RACH at Node B 110 given the fact that the system design should ensure that collisions on the RACHs are relatively infrequently.

Assignment of the C-RNTI in Message 2 in conjunction with the use of the RA-RNTI for Message 2 may enable use of Hybrid Automatic Repeat Request (HARQ) for Message 4. HARQ is typically used for a unicast transmission to a single UE. HARQ may also be employed with the RA-RNTI (which identifies a RACH) instead of the C-RNTI (which identifies a specific UE). In this case, the RA-RNTI is used to identify a single UE for a HARQ transmission of Message 4 to this UE.

In another design, which is referred to as access procedure option 2, one or more of the following features may be supported:

Message 2 is sent on L1/L2 control,
C-RNTI is assigned to UE 120 in Message 4 or later,
UE 120 is identified by an Implicit RNTI (I-RNTI) before the C-RNTI is assigned,
Message 3 may have a static or dynamic size, and
Message 4 (contention resolution) and RRC connection setup may be merged.

Option 2 may be spectrally efficient and may allow Node B 110 to respond to the random access preamble from UE 120 with a spectrally efficient Message 2 sent using an L1/L2 control message. Since the L1/L2 control message may be relatively small, an uplink resource grant may be restricted in order to make room for timing advance and/or other information. UE 120 may be identified by an I-RNTI before the C-RNTI is assigned to the UE. The I-RNTI may be formed based on (i) the RA-preamble identifier and system time at the time of system access by UE 120, (ii) the selected RACH and the RA-preamble identifier, or (iii) a combination of the selected RACH, the RA-preamble identifier, the system time, etc. The I-CRNTI may occupy a portion (e.g., several percent) of the total space for the C-RNTI.

Node B 110 may convey the following information to UE 120 in Message 2:
Timing advance (˜8 bits),
RA-preamble identifier (0 bits)—part of the I-CRNTI for UE 120, and
Location of uplink resources (˜5 bits)—sufficient for static size of Message 3.

The I-CRNTI may be exclusive-ORed (XORed) with a Cyclic Redundancy Check (CRC) generated for Message 2 or may be conveyed in other manners. Message 3 may have a static size and may be associated with a fixed transport block size, a fixed modulation and coding scheme (MCS), etc. In this case, Node B 110 may simply convey the location of the uplink resources that may be used by UE 120 to send Message 3.

In addition, Message 2 may also include any of the following:
Size of uplink resources (˜2-3 bits)—allow for dynamic size of Message 3,
Power adjustment/power control information for Message 3 (˜4-6 bits),
Timer value for Message 4 (3 bits), and
Other information.
   A restricted set of values may be available for uplink resource size. The uplink resources allocated to UE 120 may then be conveyed with fewer bits.

Message 2 may be sent using only an L1/L2 control message, which may have a total of 40 bits. Of the 40 total bits, 16 bits may be used for a CRC, and 24 bits may be available to convey the timing advance, uplink resource grant, and other information (e.g., power adjustment) for Message 3. The L1/L2 control message may also convey a timer value for Message 4, which may be used to determine how long UE 120 should wait for Message 4 from Node B 110. The location of a downlink Acknowledgement Channel (ACKCH) may be implicit and based on the location of the assigned uplink resources. Because of the limited size of Message 2, the C-RNTI may be assigned to UE 120 in Message 4 or after. The I-CRNTI may be used as the temporary UE ID before the C-RNTI is assigned to UE 120.

For both access procedure options 1 and 2, Message 2 may include a resource grant for UE 120. In general, a resource grant may explicitly and/or implicitly convey allocated downlink and/or uplink resources. For example, there may be a mapping between allocated downlink transmission resources and corresponding uplink signaling resources, e.g., for ACK, CQI, etc. Similarly, there may be a mapping between allocated uplink transmission resources and corresponding downlink signaling resources. The mapping may avoid the need to explicitly convey signaling resources, since the allocated signaling resources may be inferred from the mapping of the allocated transmission resources to the corresponding signaling resources.

Message 3 may include any of the following:
CQI—used to more efficiently send Message 4,
Power headroom information—used to control transmission of Message 4,
Buffer size information—used to control transmission of Message 4,
Radio environment report—measurements for different cells and/or frequencies,
Non-Access Stratum (NAS) messages, and
Other information.

The CQI, power headroom information, and buffer size information may each be sent in only Message 1, or only Message 3, or both Messages 1 and 3. Which particular message(s) to send each type of information may be determined based on the size of the message(s) use to send the information, the usefulness of the information for a subsequent message, etc. For example, the CQI may be sent in Message 1 if Message 2 is relatively large (e.g., for option 1) or in Message 3 if Messages 1 and 2 are relatively small (e.g., for option 2). The power headroom and buffer size information may be beneficial when Message 3 is large and/or has a dynamic size and may be sent in Message 1 and used to allocate uplink resources for Message 3. The power headroom and/or buffer size information may also be sent in Message 3 and used to control transmission of subsequent uplink messages. The CQI, power headroom information, and/or buffer size information may also be sent in other manners.

A radio environment report may be sent in Message 3 and may include pilot measurements made by UE 120 for different cells and/or different frequencies. The radio environment report may also include pilot measurements for cells and/or frequencies in other systems, e.g., GSM, W-CDMA, cdma2000, and/or other systems. Node B 110 may use the radio environment report to direct UE 120 to a suitable cell and/or a suitable frequency. A radio environment report may also be referred to as a measurement report, etc.

It may be desirable for Message 3 to accommodate NAS messages in order to speed up the access procedure. NAS messages may be used to configure the radio link between UE 120 and Node B 110 and may be sent in Message 3 (which may speed up the access procedure) and/or in later messages.

Power control may be used for Message 3 in order to reduce the amount of interference caused by Message 3 to other UEs. The benefits of power control may be greater when Message 3 is large and/or is sent with poor timing alignment at Node B 110. The poor timing alignment may be due to inaccurate timing advance sent in Message 2, which may in turn be due to collisions on the RACH, or improper detection of the access sequence sent by UE 120 (e.g., due to high speed), or some other reason. To reduce interference to other UEs, Message 3 may be sent with transmit power determined based on the power adjustment sent in Message 2.

The power adjustment may also be referred to as power control information and may be given in various formats. In one design, the power adjustment may indicate the amount of increase or decrease in transmit power and may be given with a suitable number of bits, e.g., four bits. In another design, the power adjustment may simply indicate whether the transmit power should be increased or decreased by a predetermined amount. The power adjustment may also be given in other formats.

Message 4 for contention resolution and RRC connection setup may be merged. UE 120 may repeat the access procedure if it does not receive Message 4 with its unique ID indicating that it has successfully accessed the system. It may be desirable to ensure that UE 120 uses a proper timer value so that in case Message 4 does not include successful contention resolution, then UE 120 can restart the access procedure upon expiration of the timer. Merging Message 4 and RRC connection setup may impact the timer value. In one design, a default value may be used for the timer and may be overwritten with a value broadcast on a Broadcast Channel (BCH) or specified in Message 2.

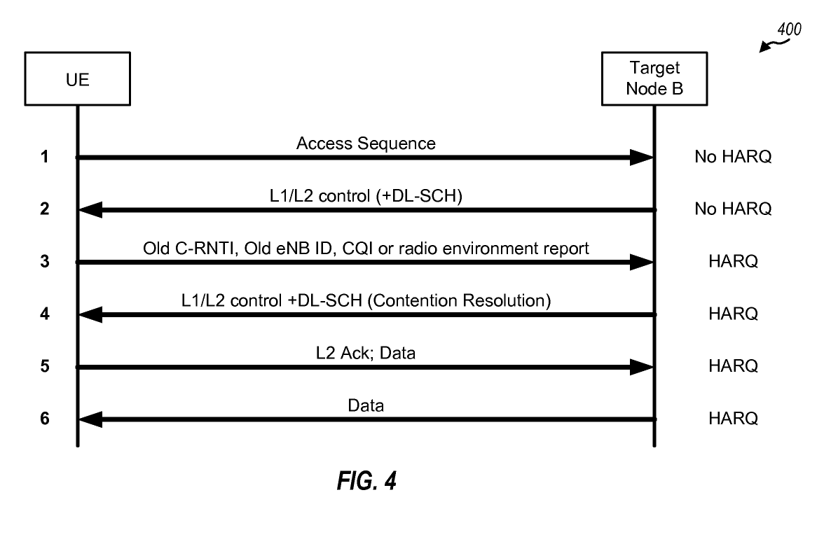

FIG. 4 shows a design of an access procedure 400 for forward handover of UE 120 from a source/old Node B to a target/new Node B. UE 120 may operate in an RRC_CONNECTED state when the handover occurs. UE 120 may access the system (e.g., due to deterioration or failure of the radio link with a serving cell) by sending an access sequence for Message 1 on a selected RACH. The access sequence may be selected from a pool of access sequences reserved for handover. Message 1 may also include any of the information shown in FIG. 3 for Message 1. The target Node B may receive Message 1 from UE 120 and may respond by sending Message 2 with an uplink resource grant for UE 120. The uplink resource grant may convey the uplink resources assigned to UE 120. The format of Message 2 for the forward handover in FIG. 4 may or may not match the format of Message 2 for the initial system access in FIG. 3.

UE 120 may then send Message 3, which may include an old C-RNTI and an ID of the old Node B in order to resolve possible collisions, to identify the UE, and to enable the target Node B to access the old Node B. Message 3 may also include the CQI in order to assist the target Node B control the transmit power for Message 4. Message 3 may also include a radio environment report, which may contain pilot measurements for different cells, different frequencies, and/or different systems. The target Node B may use the radio environment report to select a suitable cell and/or a suitable frequency for UE 120. The target Node B may receive a unique “handle” or pointer to the UE ID and may be able to resolve possible contention. The target Node B may then send Message 4 for RRC contention resolution. UE 120 may send a Layer 2 ACK for Message 4 and possible data (if any). UE 120 may thereafter exchange data with the target Node B.

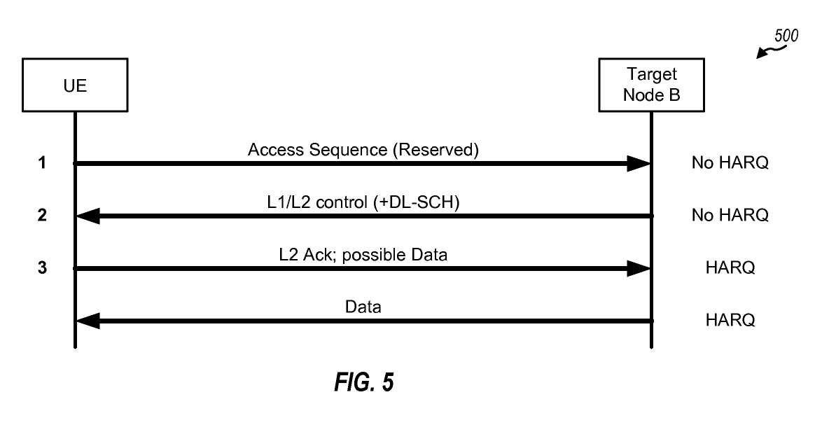

FIG. 5 shows a design of an access procedure 500 for basic handover of UE 120 from a source Node B to a target Node B. UE 120 may operate in an RRC_CONNECTED state when the handover occurs. Prior to access procedure 500, the serving Node B may send a handover request for UE 120 to the target Node B, which may accept or deny the handover request. If the handover request is accepted, then the target Node B may assign an access sequence, a C-RNTI, CQI resources, and power control resources to UE 120 and may provide this information to the source Node B. The source Node B may forward the information to UE 120, which would then have the assigned C-RNTI, CQI resources, and power control resources from the target Node B.

For access procedure 500, UE 120 may send the assigned access sequence to the target Node B. A subset of all available access sequences may be reserved for handover, and the access sequence assigned to UE 120 may be selected from this reserved subset of access sequences. Collision resolution may not be necessary due to a one-to-one mapping between the access sequence and the C-RNTI assigned to UE 120. Access procedure 500 may thus include Messages 1, 2 and 5 in access procedure 400 in FIG. 4, and Messages 3 and 4 may be omitted.

The access sequence space for the initial system access in FIG. 3 and the forward handover in FIG. 4 may be broadcast on the BCH. This broadcast access sequence space may exclude the access sequence space reserved for the basic handover in FIG. 5. Access procedure 400 may also be used for basic handover.

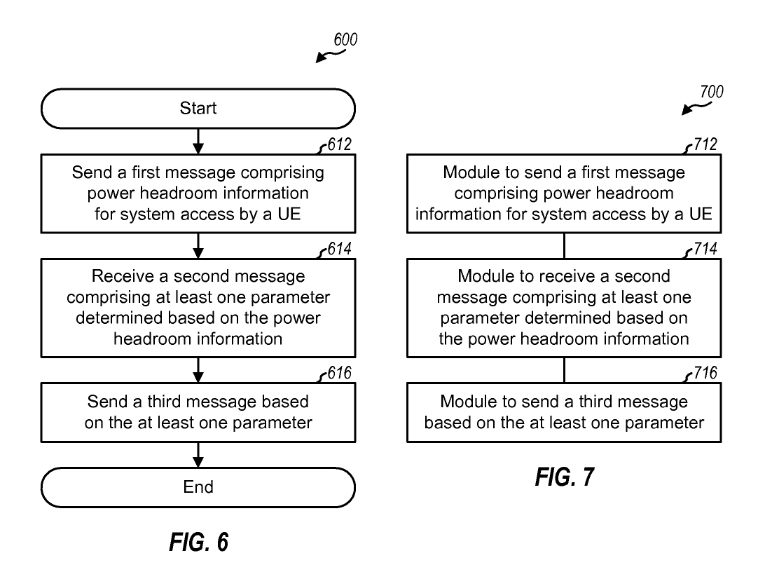

FIG. 6 shows a design of a process 600 performed by a UE for system access. A first message comprising power headroom information may be sent by the UE for system access (block 612). The power headroom information may indicate the difference between the maximum transmit power at the UE and the transmit power used for the first message. The power headroom information may also indicate whether this difference exceeds a threshold. A second message comprising at least one parameter determined based on the power headroom information may be received (block 614). The first message may further comprise buffer size information, and the at least one parameter may be determined based further on the buffer size information. For example, a message size for a third message may be selected based on the combined power headroom information and buffer size information, and the selected message size may be sent in the first message.

A third message may be sent based on the at least one parameter (block 616). The parameter(s) may comprise a resource grant, and the third message may be sent with uplink resources indicated by the resource grant. The parameter(s) may comprise power control information, and the third message may be sent with transmit power determined based on the power control information.

The first message may comprise a random access preamble and may be sent first by the UE for system access. Alternatively, the UE may send a random access preamble for the system access, receive a random access response, and send the first message in response to receiving the random access response.

FIG. 7 shows a design of an apparatus 700 for performing system access. Apparatus 700 includes means for sending a first message comprising power headroom information for system access by a UE (module 712), means for receiving a second message comprising at least one parameter determined based on the power headroom information (module 714), and means for sending a third message based on the at least one parameter (module 716).

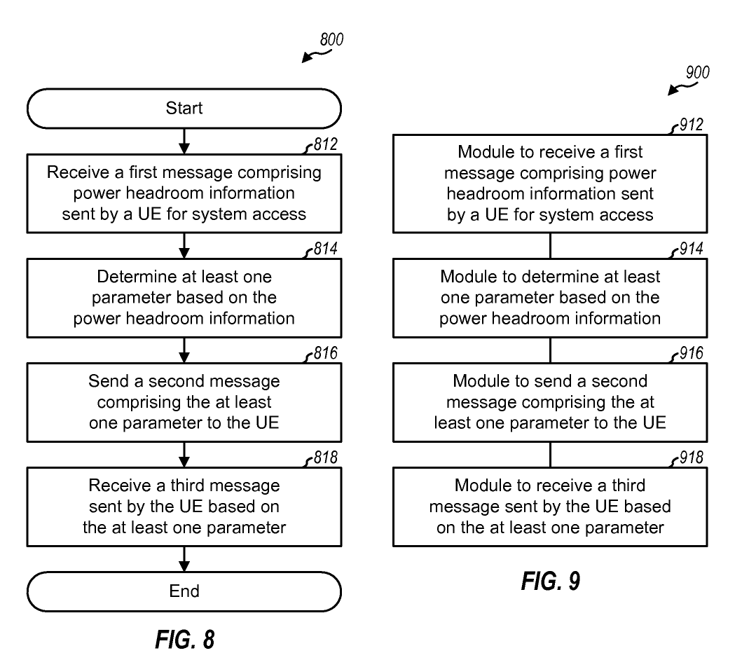

FIG. 8 shows a design of a process 800 performed by a Node B to support system access. A first message comprising power headroom information sent by a UE for system access may be received (block 812). At least one parameter may be determined based on the power headroom information (block 814). The first message may further comprise buffer size information, and the parameter(s) may be determined based further on the buffer size information. The parameter(s) may comprise an uplink resource grant, power control information, etc. A second message comprising the at least one parameter may be sent to the UE (block 816). A third message sent by the UE based on the at least one parameter may be received (block 818).

FIG. 9 shows a design of an apparatus 900 for supporting system access. Apparatus 900 includes means for receiving a first message comprising power headroom information sent by a UE for system access (module 912), means for determining at least one parameter based on the power headroom information (module 914), means for sending a second message comprising the at least one parameter to the UE (module 916), and means for receiving a third message sent by the UE based on the at least one parameter (module 918).

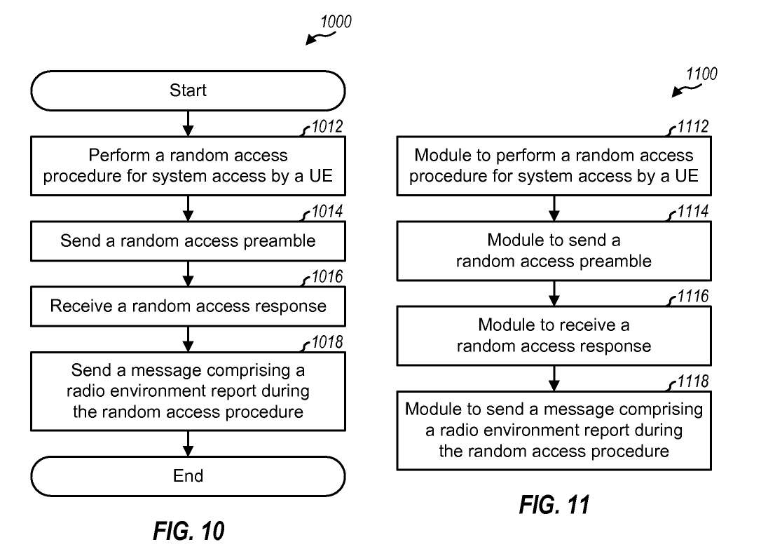

FIG. 10 shows a design of a process 1000 performed by a UE for system access. A random access procedure may be performed by the UE for system access, e.g., for handover from one Node B to another Node B (block 1012). For the random access procedure, a random access preamble may be sent initially by the UE (block 1014). A random access response may be received for the random access preamble (block 1016). A message comprising a radio environment report may be sent during the random access procedure, e.g., after receiving the random access response (block 1018). The radio environment report may comprise pilot measurements for multiple cells, multiple frequencies, and/or multiple systems. The radio environment report may be used to select a frequency and/or a cell for the UE.

FIG. 11 shows a design of an apparatus 1100 for performing system access. Apparatus 1100 includes means for performing a random access procedure for system access by a UE (module 1112), means for sending a random access preamble (module 1114), means for receiving a random access response (module 1116), and means for sending a message comprising a radio environment report during the random access procedure (module 1118).

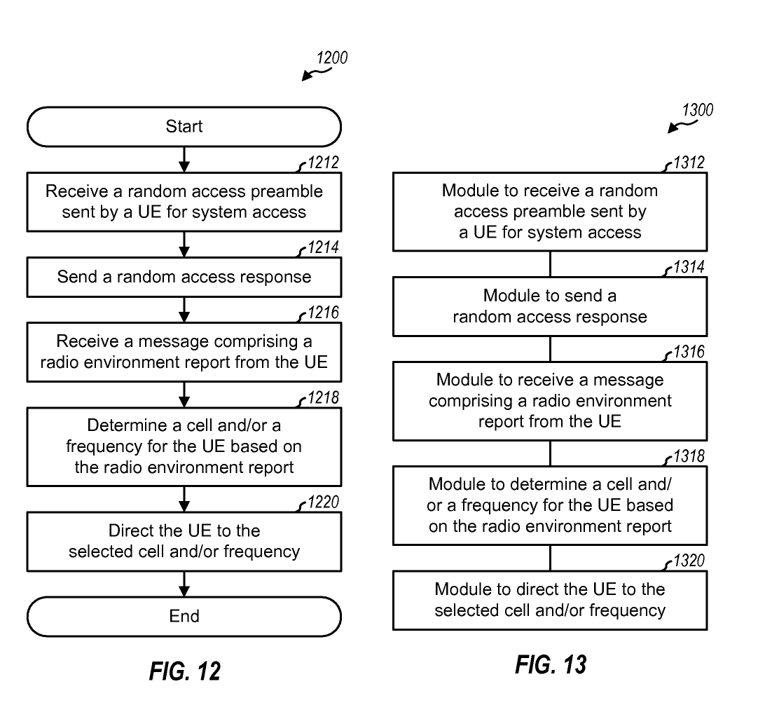

FIG. 12 shows a design of a process 1200 performed by a Node B to support system access. A random access preamble sent by a UE for system access may be received (block 1212). A random access response may be sent to the UE (block 1214). A message comprising a radio environment report may be received from the UE (block 1216). A cell and/or a frequency may be determined for the UE based on the radio environment report (block 1218). The UE may be directed to the selected cell and/or frequency (block 1220).

FIG. 13 shows a design of an apparatus 1300 for supporting system access by a Node B. Apparatus 1300 includes means for receiving a random access preamble sent by a UE for system access (module 1312), means for sending a random access response (module 1314), means for receiving a message comprising a radio environment report from the UE (module 1316), means for determining a cell and/or a frequency for the UE based on the radio environment report (module 1318), and means for directing the UE to the selected cell and/or frequency (module 1320).

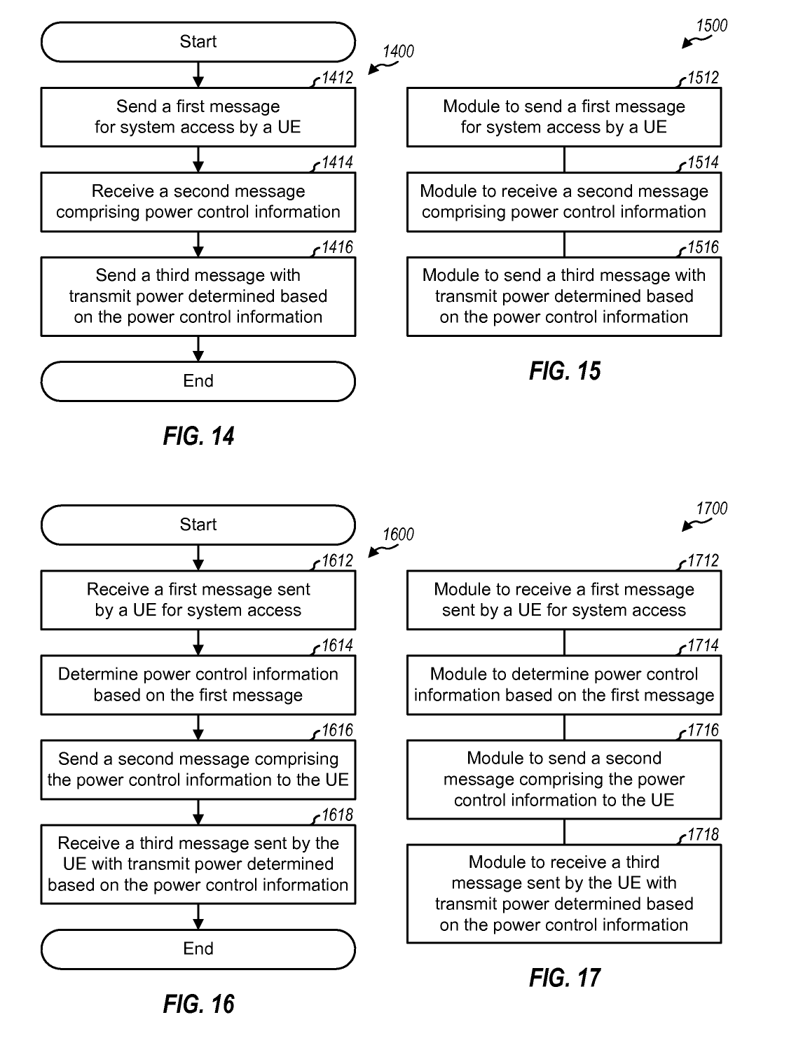

FIG. 14 shows a design of a process 1400 performed by a UE for system access. A first message may be sent by the UE for system access (block 1412). A second message comprising power control information may be received by the UE (block 1414). The power control information may be determined based on received signal quality of the first message, power headroom information sent in the first message, etc. The power control information may indicate an amount of increase or decrease in transmit power, whether to increase or decrease the transmit power by a predetermined amount, etc. A third message may be sent by the UE with transmit power determined based on the power control information and the transmit power used for the first message (block 1416).

FIG. 15 shows a design of an apparatus 1500 for performing system access. Apparatus 1500 includes means for sending a first message for system access by a UE (module 1512), means for receiving a second message comprising power control information (module 1514), and means for sending a third message with transmit power determined based on the power control information and the transmit power used for the first message (module 1516).

FIG. 16 shows a design of a process 1600 performed by a Node B to support system access. A first message sent by a UE for system access may be received (block 1612). Power control information may be determined based on the first message, e.g., based on received signal quality of the first message, power headroom information sent in the first message, etc. (block 1614). A second message comprising the power control information may be sent to the UE (block 1616). A third message sent by the UE with transmit power determined based on the power control information may be received (block 1618).

FIG. 17 shows a design of an apparatus 1700 for supporting system access by a Node B. Apparatus 1700 includes means for receiving a first message sent by a UE for system access (module 1712), means for determining power control information based on the first message (module 1714), means for sending a second message comprising the power control information (module 1716), and means for receiving a third message sent by the UE with transmit power determined based on the power control information (module 1718).

The modules in FIGS. 7, 9, 11, 13, 15 and 17 may comprise processors, electronics devices, hardware devices, electronics components, logical circuits, memories, etc., or any combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. An apparatus for wireless communication, comprising:
at least one processor configured to send a first message comprising power headroom information for system access by a user equipment (UE), to receive a second message comprising at least one parameter determined based on the power headroom information, and to send a third message based on the at least one parameter; and
a memory coupled to the at least one processor.

2. The apparatus of claim 1, wherein the power headroom information indicates a difference between maximum transmit power at the UE and transmit power used for the first message.

3. The apparatus of claim 1, wherein the power headroom information indicates whether a difference between maximum transmit power at the UE and transmit power used for the first message exceeds a threshold.

4. The apparatus of claim 1, wherein the first message further comprises buffer size information, and wherein the at least one parameter is determined based further on the buffer size information.

5. The apparatus of claim 4, wherein the at least one processor is configured to combine the power headroom information and the buffer size information, to select a message size for the third message based on the combined power headroom information and buffer size information, and to send the selected message size in the first message.

6. The apparatus of claim 1, wherein the at least one parameter comprises a resource grant, and wherein the at least one processor is configured to send the third message with uplink resources indicated by the resource grant.

7. The apparatus of claim 1, wherein the at least one parameter comprises power control information, and wherein the at least one processor is configured to send the third message with transmit power determined based on the power control information.

8. The apparatus of claim 1, wherein the first message comprises a random access preamble and is sent first for system access by the UE.

9. The apparatus of claim 1, wherein the at least one processor is configured to send a random access preamble for the system access by the UE, to receive a random access response, and to send the first message in response to receiving the random access response.

10. A method for wireless communication, comprising:
sending a first message comprising power headroom information for system access by a user equipment (UE);
receiving a second message comprising at least one parameter determined based on the power headroom information; and
sending a third message based on the at least one parameter.

11. The method of claim 10, wherein the sending the first message comprises
sending the first message comprising the power headroom information and buffer size information, and wherein the at least one parameter is determined based further on the buffer size information.

12. The method of claim 11, further comprising:
combining the power headroom information and the buffer size information; and
selecting a message size for the third message based on the combined power headroom information and buffer size information, and wherein the selected message size is sent in the first message.

13. The method of claim 10, wherein the at least one parameter comprises a resource grant, and wherein the sending the third message comprises sending the third message with uplink resources indicated by the resource grant.

14. An apparatus for wireless communication, comprising:
means for sending a first message comprising power headroom information for system access by a user equipment (UE);
means for receiving a second message comprising at least one parameter determined based on the power headroom information; and
means for sending a third message based on the at least one parameter.

15. The apparatus of claim 14, wherein the means for sending the first message comprises means for sending the first message comprising the power headroom information and buffer size information, and wherein the at least one parameter is determined based further on the buffer size information.

16. The apparatus of claim 15, further comprising:
means for combining the power headroom information and the buffer size information; and
means for selecting a message size for the third message based on the combined power headroom information and buffer size information, and wherein the selected message size is sent in the first message.

17. The apparatus of claim 14, wherein the at least one parameter comprises a resource grant, and wherein the means for sending the third message comprises means for sending the third message with uplink resources indicated by the resource grant.

18. A machine-readable medium comprising instructions which, when executed by a machine, cause the machine to perform operations including:
sending a first message comprising power headroom information for system access by a user equipment (UE);
receiving a second message comprising at least one parameter determined based on the power headroom information; and
sending a third message based on the at least one parameter.

19. An apparatus for wireless communication, comprising:
at least one processor configured to receive a first message comprising power headroom information sent by a user equipment (UE) for system access, to determine at least one parameter based on the power headroom information, to send a second message comprising the at least one parameter, and to receive a third message sent by the UE based on the at least one parameter; and
a memory coupled to the at least one processor.

20. The apparatus of claim 19, wherein the first message further comprises buffer size information, and wherein the at least one processor is configured to determine the at least one parameter based further on the buffer size information.

21. The apparatus of claim 20, wherein the at least one processor is configured to determine a resource grant for the UE based on the power headroom information and the buffer size information.

22. An apparatus for wireless communication, comprising:
at least one processor configured to perform a random access procedure for system access by a user equipment (UE), and to send a message comprising a radio environment report during the random access procedure; and
a memory coupled to the at least one processor.

23. The apparatus of claim 22, wherein the radio environment report comprises pilot measurements for at least one of multiple cells, multiple frequencies, and multiple systems.

24. The apparatus of claim 22, wherein the at least one processor is configured to send a random access preamble, to receive a random access response, and to send the message comprising the radio environment report in response to receiving the random access response.

25. The apparatus of claim 22, wherein the at least one processor is configured to perform the random access procedure for handover from a first base station to a second base station.

26. An apparatus for wireless communication, comprising:
at least one processor configured to receive a random access preamble sent by a user equipment (UE) for system access, to send a random access response to the UE, and to receive a message comprising a radio environment report from the UE; and
a memory coupled to the at least one processor.

27. The apparatus of claim 26, wherein the at least one processor is configured to determine a cell or a frequency for the UE based on the radio environment report.

28. An apparatus for wireless communication, comprising:
at least one processor configured to send a first message for system access by a user equipment (UE), to receive a second message comprising power control information, and to send a third message with transmit power determined based on the power control information; and
a memory coupled to the at least one processor.

29. The apparatus of claim 28, wherein the at least one processor is configured to send power headroom information in the first message, and wherein the power control information is determined based on the power headroom information.

30. The apparatus of claim 28, wherein the at least one processor is configured to determine transmit power for the third message based on the power control information and transmit power for the first message.

31. The apparatus of claim 28, wherein the power control information indicates an amount of increase or decrease in transmit power or indicates whether to increase or decrease transmit power by a predetermined amount.

32. The apparatus of claim 28, wherein the at least one processor is configured to send channel quality indicator (CQI) in the first message, and to receive the second message sent with a modulation and coding scheme (MCS) or with transmit power determined based on the CQI.

33. A method for wireless communication, comprising:
sending a first message for system access by a user equipment (UE);
receiving a second message comprising power control information; and
sending a third message with transmit power determined based on the power control information.

34. The method of claim 33, wherein the sending the first message comprises sending power headroom information in the first message, and wherein the power control information is determined based on the power headroom information.

35. The method of claim 33, further comprising:
determining transmit power for the third message based on the power control information and transmit power for the first message.

36. An apparatus for wireless communication, comprising:
at least one processor configured to receive a first message sent by a user equipment (UE) for system access, to send a second message comprising power control information to the UE, and to receive a third message sent by the UE with transmit power determined based on the power control information; and
a memory coupled to the at least one processor.

37. The apparatus of claim 36, wherein the at least one processor is configured to receive power headroom information in the first message, to determine received signal quality of the first message, and to determine the power control information based on the received signal quality and the power headroom information.

38. The apparatus of claim 36, wherein the at least one processor is configured to receive channel quality indicator (CQI) in the first message, and to determine a modulation and coding scheme (MCS) or transmit power for the second message based on the CQI.
